(19) United States
(12) Patent Application Publication
(10) Pub. No.: US 2018/0320056 A1
(43) Pub. Date: Nov. 8, 2018

(54) SUSPENSIONS OF NONPOLAR NANOPARTICLES FOR ENHANCED RECOVERY OF HEAVY OILS

(71) Applicant: BAKER HUGHES INCORPORATED, Houston, TX (US)

(72) Inventors: Oleg A. Mazyar, Katy, TX (US); Anil K. Sadana, Houston, TX (US); Qusai A. Darugar, Houston, TX (US)

(73) Assignee: BAKER HUGHES INCORPORATED, Houston, TX (US)

(21) Appl. No.: 15/586,692

(22) Filed: May 4, 2017

(51) Int. Cl. C09K 8/584; C09K 8/58; E21B 43/16

(52) U.S. Cl. CPC C09K 8/584; C09K 2208/10; E21B 43/16; C09K 8/58

(57) ABSTRACT

Heavy oils are recovered from subterranean formations by introducing a suspension of nonpolar nanoparticles in a non-aqueous fluid into the subterranean formation containing the heavy oil, contacting the heavy oil with the suspension, and simultaneously removing at least a portion of the heavy oil with the suspension from the subterranean formation. Suitable nanoparticles include those of a size between about 2 to about 10,000 nm, and which include, but are not necessarily limited to, crosslinked polymers, diamond, graphite, graphene, carbon nanotubes, coal, carbon black, activated carbon, asphaltene, petrocoke, resins, functionalized fly ash, nanoparticles functionalized with polymers to be nonpolar, and combinations thereof.

### TECHNICAL FIELD

The present invention relates to compositions and methods for removing heavy oils from subterranean formations, and more particularly relates, in one non-limiting embodiment, to compositions and methods for removing heavy oils from subterranean formations using suspensions of nanoparticles.

### TECHNICAL BACKGROUND

Hydrocarbon (e.g., crude oil, or simply oil) recovery may be classified as primary, secondary and tertiary recovery. In primary recovery, the crude oil is simply drawn out of a subterranean formation by a pumping action. The high natural differential hydrostatic pressure resulting from the overlying strata drives the oil toward the pumped well. Primary recovery methods usually recover only 20-30% of the original oil estimated to be in the formation. Secondary recovery refers to the injection of pressurized liquid water or water vapor (steam) into the formation via a bore pipe. The additional pressure of the injected water, and/or the heating action of the steam drives more of the crude oil toward the pumped well. In such a manner, an additional 10-20% of the original oil estimated to be in the formation may be recovered. Tertiary recovery involves methods to reduce the viscosity and dissolve the oil and/or increase its mobility in some fashion. Injecting liquid or supercritical carbon dioxide into the formation (e.g., CO₂ flooding) is another common tertiary recovery method. In such a process, liquid or supercritical CO₂ is injected via a bore pipe. Carbon dioxide is readily miscible with crude oil and reduces its viscosity, thereby allowing the oil/CO₂ mixture to more easily flow toward the pumped well.

Another enhanced oil recovery (EOR) technique is Steam Assisted Gravity Drainage (SAGD) for producing heavy crude oil and bitumen. It is an advanced form of steam stimulation in which at least two horizontal wells are drilled into a subterranean oil reservoir, one a few feet or meters above the other. High pressure steam is continuously injected into the upper wellbore to heat the oil or bitumen and reduce its viscosity, causing the heated oil to drain into the lower wellbore, where it is pumped out. SAGD was developed to recover deposits of bitumen that were too deep for mining. SAGD is presently used to produce oil sands, most notably those in Alberta, Canada, and also heavy crude oil. Canada is the single largest supplier of imported oil to the United States. As defined herein, heavy oil is defined as having a specific gravity of less than 22.3° API.

Heavy oil on the porous subterranean rock surfaces forms oil films which are difficult to dissolve or remove by conventional methods, and these films tend to remain in the reservoir during primary recovery processes and conventional EOR processes, thereby leaving significant amounts of hydrocarbons in the reservoir.

Accordingly, it is desired to provide compositions and methods which provide alternative ways for removing heavy oil from the porous rock surfaces in subterranean formations.

### SUMMARY

There is provided in one non-limiting embodiment a method for recovering heavy oil from a subterranean formation that includes introducing a suspension of nonpolar nanoparticles in a non-aqueous fluid into the subterranean formation containing heavy oil, contacting the heavy oil with the suspension, and simultaneously removing at least a portion of the heavy oil in contact with the suspension from the subterranean formation.

### DETAILED DESCRIPTION

A method has been discovered for recovering heavy oil from subterranean formations using non-aqueous suspensions of nonpolar nanoparticles by introducing such suspensions into the oil-bearing formations containing this heavy oil. By “recovering heavy oil from subterranean formations” is meant any portions the subterranean formation close to, but also at a distance from a wellbore.

The nonpolar nanoparticles are suspended in non-aqueous fluid typically used for reduction of the viscosity of heavy oils including, but not necessarily limited to, light crude oils, naphtha, kerosene, toluene, organic solvents other than hydrocarbons, and mixtures thereof. The organic solvents in turn may include, but are not necessarily limited to, (methyl tert-butyl ether, tert-amyl methyl ether, pentanol, hexanol, methylethylketone, dimethyl ether) and mixtures thereof.

The nanoparticles may be covalently or non-covalently functionalized to achieve stability in the suspension. Suitable nanoparticles include, but are not necessarily limited to, crosslinked polymer nanoparticles, diamond nanoparticles, graphite, graphene, carbon nanotubes, coal particles, carbon black particles, activated carbon particles, asphaltene particles, petrocoke particles, resin particles, fluorocarbon particles, functionalized fly ash, and combinations thereof. In one non-limiting embodiment, the nonpolar nanoparticles do not include, or have an absence of nanoparticle iron crown ether complexes.

It is believed that polymer nanoparticles are suitable if the polymer is crosslinked to keep them from “unfolding” during contact or collision with the heavy oil film in the pore spaces during the recovery of the heavy oil from the formation. Suitable crosslinked polymers include, but are not necessarily limited to, crosslinked forms of polystyrene, polyurethane, polyurea, polyethylene, polyvinylidene fluoride, polyether ether ketone, polyether ketone, polyaryletherketone, polyetherketoneketone, polyetherimide, polyphenylene sulfide, polysulfone, polyethersulfone, and combinations thereof.

Petrocoke is also known as “petroleum coke”, “pet coke”, or “petcoke”, and is a final carbon-rich solid material that derives from oil refining. The resin particles include, but are not necessarily limited to, without limitation, latex, polystyrene, and the like. Specific examples of latex nanoparticles include, but are not necessarily limited to carboxylate-modified latex beads having mean particles sizes of 0.05 μm, 0.03 μm, 0.25 μm and ranges in between these amounts, reacted with alkylamines to render the particles hydrophobic and oleophilic. One suitable commercially available type of latex amine-modified polystyrene nanoparticles are the AQUEOES latex beads L6780, L6030, L5155, L6155, and the like, but these beads are additionally derivatized to be fluorescent tracers, which property is unnecessary for the present method. Nanoparticles that have been functionalized with nanoparticles to be nonpolar, that is hydrophobic and oleophilic, would also be suitable. Suitable polymers for such functionalization include, but are not necessarily limited to, polyacetylene, polystyrene, polymethyl methacrylate, polyglycidyl methacrylate, and combinations thereof

Since functionalization of metal oxides, metalloid oxides, nitrides, and carbides with high surface coverage of functional groups renders the nano-particles nonpolar, they also can be used in this embodiment. Metalloids are defined herein as chemical elements which have properties in between those of metals and non-metals, or that have mixtures of them. More specifically, metal-loids include, but are not necessarily limited to, boron, silicon, germanium, antimony, and tellurium. Suitable polar nanoparticles that have been functionalized with non-polar groups include, but are not necessarily limited to, organically modified hydrophilic nanoclays such as halloysite, montmorillonite, bentonite, and the like, where specific examples include, but are not necessarily limited to CLOISITE-5, CLOISITE-15, CLOISITE-20, and the available from BYK Additives & Instruments. Other suitable polar nanoparticles that have been functionalized with non-polar groups include, but are not necessarily limited to, organically modified hydroxyapatite, in non-limiting examples, hydroxyapatite treated with appropriate alkoxysilanes, chlorosilanes, or cyclic azasilanes).

Useful functional groups on the nonpolar nanoparticles include, but are not necessarily limited to, linear or branched alkyl, aryl, linear or branched alkylaryl, or linear or branched arylalkyl, and combinations thereof, where the number of carbon atoms in the alkyl, aryl, alkylaryl, and/or arylalkyl groups ranges from 4 to 12.

As noted, the nonpolar nanoparticles may be functionalized fly ash particle. The components of fly ash vary considerably, but all fly ash includes substantial amounts of silicon dioxide (SiO₂) (both amorphous and crystalline), aluminum oxide (Al₂O₃), calcium oxide (CaO), and Fe₂O₃. Thus, fly ash particles can be functionalized with appropriate alkoxysilanes, chlorosilanes, and cyclic azasilanes.

Additionally, both the nanoparticles and functional groups can be fluorinated or perfluorinated; e.g., without limitation, fluorinated nanodiamond. While fluorine is the most electronegative element and the C—F bond is polar, fluoroalkanes tend to have a small tendency to adhere to surfaces. Without wishing to be bound by any theory, the fluorine atom is too electronegative to donate its electrons for coordinate bond formation, and thus such nanoparticles are nonpolar.

The nonpolar nanoparticles have an average particle size of between about 2 independently to about 10,000 nm; alternatively from about 5 independently to about 75 nm; in another non-restrictive embodiment from about 10 independently to about 200 nm. When the word “independently” is used herein with respect to a range, any one threshold may be used together with any other threshold to give a suitable alternative range. It will be appreciated that although these particles are called “nonpolar nanoparticles”, they may have sizes somewhat larger than the nanoparticle range, that is, up to about 10,000 nm, i.e. up to 10 microns. Alternatively, the upper threshold of the average particle size for the nanoparticles may be 999 nm.

The above-described nanosuspension can be introduced into the reservoir to contact and dilute the heavy oil and, thus, to reduce its viscosity. Without wishing to be bound by any one theory, the nanoparticles' role is to abrasively remove or at least partially disintegrate the hydrocarbon coating on the rock surfaces so that the solvent could dissolve it in the bulk fluid, to facilitate mixing of the heavy oil with the bulk fluid, and/or to prevent formation of asphaltene or paraffin aggregates that may precipitate from heavy oil when solvent/diluent is introduced into the formation. Because the nanoparticles are nonpolar, they do not adhere to the rock surfaces. Thus, the nonpolar nanoparticles can be recovered with the produced oil and reused.

The amount of nonpolar nanoparticles in the non-aqueous fluid of the suspension ranges from about 0.01 independently to about 15 wt %; alternatively from about 0.1 independently to about 1.5 wt %.

There is no particular method of introducing the suspension of nonpolar nanoparticles downhole. They may be simply pumped downhole and through the formation to contact the heavy oil in a conventional fashion. The contacting of the heavy oil is for a sufficient time to mix the suspension with the oil, and the contact time will vary depending upon a number of factors including, but not necessarily limited to, the proportion of suspension used, the viscosity of the heavy oil, the temperature of the suspension and the heavy oil, and the like. At least a portion of the heavy oil is recovered from the subterranean formation with the suspension simultaneously. That is, while a goal is to recover heavy oil, it is also acceptable if the suspension is recovered from the formation. The heavy oil is recovered for conventional processing and the nonpolar nanoparticles may be recovered for reuse. The recovery of the heavy oil and the suspension of nonpolar nanoparticles may be from a production well separate from the injection well, or the flow may be reversed and the heavy oil and the suspension of nonpolar nanoparticles may be recovered from the same injection well used to introduce the suspension.

In another non-limiting embodiment, the nonpolar nanoparticles may have polar cores (including but not necessarily limited to those previously described) that are covalently or non-covalently functionalized with oleophilic groups and surfactants may interact with these cores with their polar heads while their non-polar tails extend into the oil, thus helping to stabilize particles in the oil. Such surfactants may include, but are not necessarily limited to, cationic surfactants, anionic surfactants, non-ionic surfactants, amphiphilic surfactants, and combinations thereof. Suitable anionic surfactants include, but are not necessarily limited to, internal olefin sulfonates, alcohol alkoxy sulfates, alkyl alkoxy carboxylates, sodium dodecyl sulfate, sodium dodecylbenzenesulfonate, sodium laureth sulfate, sodium stearate, sodium laurate, ammonium lauryl sulfate, sodium docusate, alkyl-aryl ether phosphates, alkyl ether phosphates, perfluorooctanesulfonate, perfluorobutanesulfonate, perfluorononanoate, perfluorooctanoate, and combinations thereof. Suitable cationic surfactants include, but are not necessarily limited to, primary, secondary, or tertiary amines, cetrimonium bromide, cetylpyridinium chloride, benzalkonium chloride, benzethonium chloride, dimethyldioctadecylammonium chloride, dioctadecyldimethylammonium bromide, and combinations thereof. Suitable zwitterionic surfactants include, but are not necessarily limited to, 3-[(3-cholamidopropyl)dimethylammonio]-1-propanesulfonate, cocamidopropyl hydroxysultaine, lauryldimethylamine oxide, and combinations thereof. Suitable nonionic surfactants include, but are not necessarily limited to, fatty alcohols, cetyl alcohol, stearyl alcohol, oleyl alcohol, polyethylene glycol alkyl ethers, polypropylene glycol alkyl ethers, glucoside alkyl ethers, polyethylene glycol octylphenyl ethers, polyethylene glycol alkylphenyl ethers, glycerol alkyl esters, polyoxyethylene glycol sorbitan alkyl esters, polyethoxylated tallow amine, and combinations thereof. In some embodiments, surfactants act as functional groups non-covalently attached to polar cores. In another non-limiting embodiment, surfactants may be added to suspensions containing functionalized or non-functionalized nanoparticles having nonpolar cores. Yet in another embodiment, surfactants are used in suspensions containing a combination of nanoparticles having polar and nonpolar cores of various sizes. Nonpolar particles having polar core may be additionally stabilized by surrounding nano-particles having nonpolar cores preferably of the smaller size.

Suitable cosolvents to use in connection with the above-noted suspensions of nonpolar nanoparticles include, but are not necessarily limited to, methanol, ethanol, glycerol, propylene carbonate, ethylene carbonate, 1-cyclohexyl-2-pyrrolidone, diethylene glycol monobutyl ether, isopropanol, 1-methyl-2-pyrrolidone, 2-amino-2-methyl-1-propanol, methyl diethanol amine, pyrazole, benzyl alcohol, 1,3-dimethyl-2-imidazolidinone, propylene glycol monomethyl ether, dipropylene glycol monomethyl ether, tripropylene glycol monomethyl ether, propylene glycol mono-t-butyl ether, ethylene glycol ethyl ether acetate, ethylene glycol methyl ether acetate, ethylene glycol butyl ether, diethylene glycol butyl ether acetate, propylene glycol methyl ether acetate, dipropylene glycol methyl ether acetate, tripropylene glycol methyl ether acetate, and mixtures thereof.

In summary, the methods and compositions described herein may be used to remove heavy oil from a subterranean formation particularly in, but not exclusively in, an EOR operation. The heavy oil being removed by the methods described herein is not limited by other components present including, but not necessarily limited to, water, and contaminants including, but not necessarily limited to, asphaltenes, sulfides, metal complexes, hydrates, etc.

In the foregoing specification, the invention has been described with reference to specific embodiments thereof, and has been demonstrated as effective in providing methods and compositions for improving and increasing the removal of heavy oil from a subterranean formation. However, it will be evident that various modifications and changes can be made thereto without departing from the broader scope of the invention as set forth in the appended claims. Accordingly, the specification is to be regarded in an illustrative rather than a restrictive sense. For example, specific combinations of heavy oils, non-aqueous fluids, nonpolar nanoparticles, functional groups, surfactants, and other components and proportions thereof, falling within the claimed parameters, but not specifically identified or tried in a particular composition or method, are expected to be within the scope of this invention. Additionally, it is expected that the methods of removing the heavy oil may change somewhat from one field to another or one application to another and still accomplish the stated purposes and goals of the methods described herein. Further, the methods herein may use different methods, temperatures, pressures, pump rates and additional or different steps than those mentioned or exemplified herein and still be encompassed by the claims herein.

The present invention may suitably comprise, consist of or consist essentially of the elements disclosed and may be practiced in the absence of an element not disclosed. For instance, there may be provided a method for recovering heavy oil from a subterranean formation comprising, consisting essentially of, or consisting of introducing a suspension of nonpolar nanoparticles in a non-aqueous fluid into the subterranean formation containing heavy oil, contacting the heavy oil with the suspension, and simultaneously removing at least a portion of the heavy oil in contact with the suspension from the subterranean formation.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for recovering heavy oil from a subterranean formation comprising:
introducing a suspension of nonpolar nanoparticles in a non-aqueous fluid into the subterranean formation containing heavy oil;
contacting the heavy oil with the suspension; and
simultaneously removing at least a portion of the heavy oil in contact with the suspension from the subterranean formation.

2. The method of claim 1 where the heavy oil is defined as having a specific gravity of less than 22.3° API.

3. The method of claim 1 where the non-aqueous fluid is selected from the group consisting of:
condensates,
light crude oils,
naphtha,
kerosene,
toluene,
organic solvents selected from the group consisting of methyl tert-butyl ether, tert-amyl methyl ether, pentanol, hexanol, methylethylketone, dimethyl ether, and mixtures thereof; and
mixtures thereof.

4. The method of claim 1 where the nonpolar nanoparticles have an average particle size of between about 2 to about 10,000 nm.

5. The method of claim 1 where the amount of nonpolar nanoparticles in the suspension ranges from about 0.01 to about 15 wt %.

6. The method of claim 1 where in the suspension the nonpolar nanoparticles are selected from the group consisting of crosslinked polymers, diamond, graphite, graphene, carbon nanotubes, coal, carbon black, activated carbon, asphaltene, petrocoke, resins, functionalized fly ash, nanoparticles functionalized with polymers to be nonpolar, and combinations thereof.

7. The method of claim 1 where the nonpolar nanoparticles have functional groups selected from the group consisting of linear or branched alkyl, aryl, linear or branched alkylaryl, or linear or branched arylalkyl, and combinations thereof, where the number of carbon atoms in the alkyl, aryl, alkylaryl, and arylalkyl groups ranges from 4 to 12.

8. The method of claim 8 where the nonpolar nanoparticles or the functional groups on the nonpolar nanoparticles are fluorinated or perfluorinated.

9. The method of claim 1 where the nonpolar nanoparticles comprise a polar core functionalized with surfactants to be nonpolar.

10. The method of claim 9 where the suspension further comprises at least one cosolvent.

11. The method of claim 1 where the suspension further comprises at least one surfactant.

12. The method of claim 1 where the suspension further comprises at least one cosolvent.

13. A method for recovering heavy oil from a subterranean formation comprising:
introducing a suspension of nonpolar nanoparticles in a non-aqueous fluid into the subterranean formation containing heavy oil,
where the heavy oil has a specific gravity of less than 22.3° API,
where the non-aqueous fluid is selected from the group consisting of:
condensates,
light crude oils,
naphtha,
kerosene,
toluene,
organic solvents selected from the group consisting of methyl tert-butyl ether, tert-amyl methyl ether, pentanol, hexanol, methylethylketone, dimethyl ether, and mixtures thereof; and
mixtures thereof; and
where the nonpolar nanoparticles are selected from the group consisting of crosslinked polymers, diamond, graphite, graphene, carbon nanotubes, coal, carbon black, activated carbon, asphaltene, petrocoke, resins, functionalized fly ash, and combinations thereof;
contacting the heavy oil with the suspension; and
simultaneously removing at least a portion of the heavy oil in contact with the suspension from the subterranean formation.

14. The method of claim 13 where the nonpolar nanoparticles have an average particle size of between about 2 to about 10,000 nm.

15. The method of claim 13 where the amount of nonpolar nanoparticles in the suspension ranges from about 0.01 to about 15 wt %.

16. A method for recovering heavy oil from a subterranean formation comprising:
introducing a suspension of nonpolar nanoparticles in a non-aqueous fluid into the subterranean formation containing heavy oil, where the nonpolar nanoparticles have an average particle size of between about 2 to about 10,000 nm, and where the amount of nonpolar nanoparticles in the suspension ranges from about 0.01 to about 15 wt %;
contacting the heavy oil with the suspension; and
simultaneously removing at least a portion of the heavy oil in contact with the suspension from the subterranean formation.

17. The method of claim 16 where the heavy oil is defined as having a specific gravity of less than 22.3° API.

18. The method of claim 16 where the non-aqueous fluid is selected from the group consisting of:
condensates,
light crude oils,
naphtha,
kerosene,
toluene,
organic solvents selected from the group consisting of methyl tert-butyl ether, tert-amyl methyl ether, pentanol, hexanol, methylethylketone, dimethyl ether, and mixtures thereof; and
mixtures thereof.

19. The method of claim 16 where in the suspension the nonpolar nanoparticles are selected from the group consisting of crosslinked polymers, diamond, graphite, graphene, carbon nanotubes, coal, carbon black, activated carbon, asphaltene, petrocoke, resins, functionalized fly ash, and combinations thereof.
